(19) United States
(12) Patent Application Publication
(10) Pub. No.: US 2013/0218639 A1
(43) Pub. Date: Aug. 22, 2013

(54) QUESTIONNAIRE CREATION SUPPORTING SYSTEM, QUESTIONNAIRE IMPLEMENTING APPARATUS, AND RECORDING MEDIUM

(71) Applicant: Masaharu Nakagawa, Yokohama (JP)

(72) Inventor: Masaharu Nakagawa, Yokohama (JP)

(73) Assignee: HITACHI, LTD., Tokyo (JP)

(21) Appl. No.: 13/819,857

(22) PCT Filed: Sep. 24, 2010
(86) PCT No.: PCT/JP2010/066485

§ 371 Date: May 9, 2013

(51) Int. Cl. G06Q 30/02

(52) U.S. Cl. CPC G06Q 30/0203
USPC 705/7.32

(57) ABSTRACT

A questionnaire creation supporting system includes a terminal apparatus for answering used by a respondent to a questionnaire in which a plurality of questions to be answered with numerical values are presented and a questionnaire implementing apparatus connected to the terminal apparatus for answering and configured to implement the questionnaire. The questionnaire implementing apparatus acquires, a selection order, which is the order for updating questions presented in the past to a lower-order layer, places the questions in order according to the acquired selection order, acquires lower-order questions from the question information, sets the order of the acquisition of the lower-order questions as a new version of the presentation order, stores, a questionnaire pattern that indicates the acquired lower-order questions and the new version of the presentation order, and displays, according to the stored presentation order, the acquired lower-order questions on the terminal apparatus for answering.

### TECHNICAL FIELD

The present invention relates to a questionnaire creation supporting system, a questionnaire implementing apparatus, and a recording medium.

### BACKGROUND ART

When a company provides customers with a service, in general, the company acquires degrees of satisfaction of the customers to the service in a form of a questionnaire and analyzes a result of the questionnaire to further improve the service. Techniques for creating questions of a questionnaire have been disclosed. For example, Patent Literature 1 discloses a technique for changing questions with high selectivity to more specific questions. Patent Literature 2 discloses a technique for grouping customers and creating branch scenarios of questions for each of the groups.

### CITATION LIST

### Patent Literature

Patent Literature 1: JP-A-2007-172340 (abstract, etc.)
Patent Literature 2: JP-A-2004-287667 (claim 1, etc.)

### SUMMARY OF INVENTION

### Technical Problem

In a questionnaire, taking into account a work load of customers, for example, a method of causing the customers to select one of numerical values in stages 1 to 5 is often used. Question contents are gradually detailed and specified according to answers. When such a method is used, even if degrees of satisfaction are the same objectively, it often occurs that some customers select “5” and the other customers select “4”. It is necessary to exclude such subjectivity of each of the customers. Further, if questions presented in one questionnaire are fixed, when a customer selects an answer with a tendency different from that in the past with respect to a certain question, questions prepared after the question are sometimes meaningless.

The techniques disclosed in Patent Literature 1 and Patent Literature 2 cannot be used for a questionnaire of a numerical value evaluation type. The techniques cannot solve the problems concerning the exclusion of subjectivity and the fixation of questions.

Therefore, it is an object of the present invention to optimize questions of the questionnaire of the numerical value evaluation type according to tendencies of answers to thereby accurately grasp evaluations of customers.

### Solution to Problem

A questionnaire creation supporting system according to the present invention includes: a terminal apparatus for answering used by a respondent to a questionnaire in which a plurality of questions to be answered with numerical values are presented; and a questionnaire implementing apparatus connected to the terminal apparatus for answering and configured to implement the questionnaire. The questionnaire implementing apparatus includes: a storing unit having stored therein question information in which the questions that should be presented in the questionnaire are hierarchically stored and a questionnaire pattern that indicates, in association with the respondent, the questions and presentation order, which is order in which the questions should be presented in the questionnaire; and a control unit configured to acquire, according to a representative value of numerical values of answers to questions presented in the past, selection order, which is order for updating the questions presented in the past to a lower-order layer, place the questions presented in the past in order according to the acquired selection order, acquire lower-order questions concerning the questions presented in the past from the question information, set order of the acquisition of the lower-order questions as a new version of the presentation order, update, in association with the respondent, the questionnaire information with the questionnaire pattern that indicates the acquired lower-order questions and the new version of the presentation order, and display, according to the updated presentation order, the acquired lower-order questions on the terminal apparatus for answering.

Other means is explained in the description of embodiments.

### Advantageous Effect of Invention

According to the present invention, it is possible to accurately grasp evaluations of customers by optimizing questions of the questionnaire of the numerical value evaluation type according to tendencies of answers.

### BRIEF DESCRIPTION OF DRAWINGS

FIG. 1 is a configuration diagram of a questionnaire creation supporting system according to an embodiment.

FIG. 2 is a diagram showing an example of a list answer screen according to the embodiment.

FIGS. 3(a) and (b) are diagrams showing examples of a sequential answer screen according to the embodiment.

FIG. 4 is a diagram showing an example of setting information according to the embodiment.

FIG. 5 is a diagram showing an example of question information according to the embodiment.

FIG. 6 is a diagram showing an example of common questionnaire information according to the embodiment.

FIG. 7 is a diagram showing an example of per-customer questionnaire information according to the embodiment.

FIG. 8 is a diagram showing an example of answer information according to the embodiment.

FIG. 9 is a diagram showing an example of questionnaire pattern transition information according to the embodiment.

FIG. 10 is a flowchart of an overall processing procedure according to the embodiment.

FIG. 11 is a detailed flowchart of step S303 according to the embodiment.

FIG. 12 is a detailed flowchart of steps S407, S408, and S409 according to the embodiment.

FIG. 13 is a detailed flowchart of step S304 according to the embodiment.

FIG. 14 is a detailed flowchart of step S607 according to the embodiment.

FIG. 15 is a diagram for explaining a mechanism for determining that a customer is distinctive according to the embodiment.

### DESCRIPTION OF EMBODIMENTS

A modes for carrying out the present invention (referred to as “this embodiment”) is hereinafter explained in detail with reference to the drawings and the like.

Questionnaire Creation Supporting System

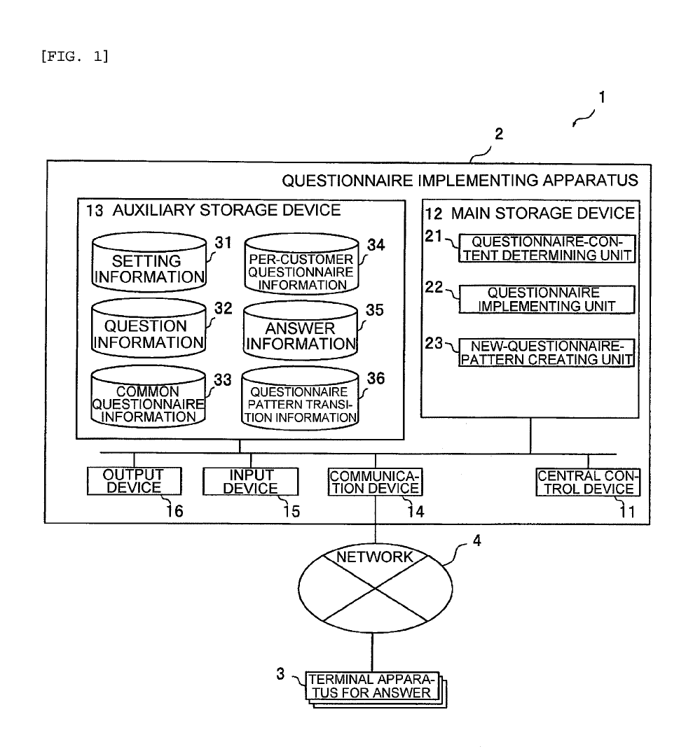

A questionnaire creation supporting system 1 shown in FIG. 1 includes a questionnaire implementing apparatus 2 managed by a questionnaire implementer and terminal apparatuses for answering 3 used by customers of the questionnaire implementers. These apparatuses are connected to each other via a network 4.

The questionnaire implementing apparatus 1 is a general computer. The questionnaire implementing apparatus 1 includes a central control device 11, a main storage device 12, an auxiliary storage device 13, a communication device 14, an input device 15, and an output device 16. These devices are connected to one another by a bus.

The auxiliary storage device 13 has stored therein setting information 31, question information 32, common questionnaire information 33, per-customer questionnaire information 34, answer information 35, and questionnaire pattern transition information 36 (all of which are explained in detail below).

A questionnaire-content determining unit 21, a questionnaire implementing unit 22, and a new-questionnaire-pattern creating unit 23 are programs. In the following explanation, when a subject is described as “ . . . unit”, the central control device 11 reads out the programs from the auxiliary storage device 13, loads the programs into the main storage device 12, and then realizes functions of the programs (explained in detail below).

The terminal apparatus for answering 3 is also a general computer. The terminal apparatus for answering 3 includes a central control device, a main storage device, an auxiliary storage device, a communication device, an input device, and an output device. These devices are connected to one another by a bus (not shown in the figure).

In FIG. 1, one questionnaire implementing apparatus 2 is present. However, the questionnaire implementing apparatus 2 may be configured to be divided into a plurality of housings. For example, one or a plurality of apparatuses that store the programs and one or a plurality of apparatuses that store the kinds of information may be present. Further, the number of the terminal apparatuses for answering 3 is also arbitrary.

Questionnaire Answer Screen

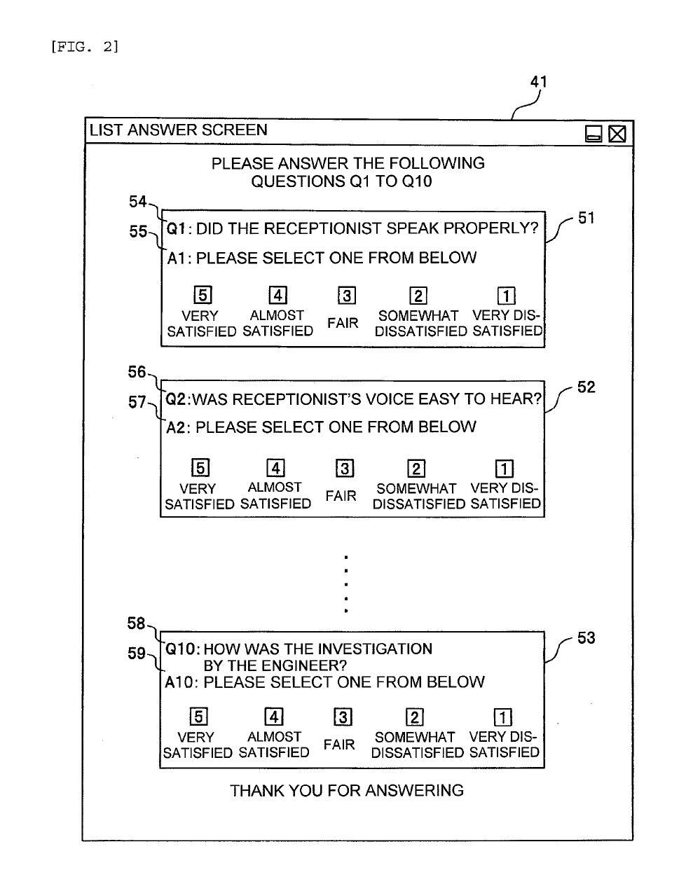

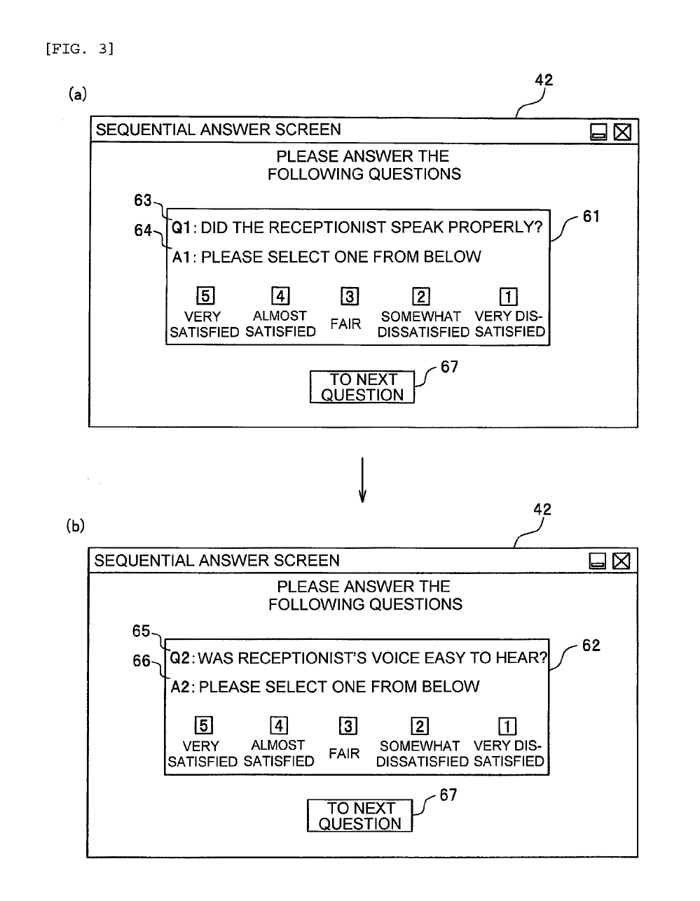

A screen example is explained with reference to FIGS. 2 and 3. In the screen example, a questionnaire implementer that provides various job applications implements a questionnaire for customers concerning the quality of a support service for the applications. The questionnaire implementing apparatus 2 creates answer screens explained below and displays the answer screens on the output device of the terminal apparatus for answering 3.

On a list answer screen 41 shown in FIG. 2, questions 54, 56, and 58 are paired with answer options 55, 57, and 59 and arranged from up to down (columns 51, 52, and 53).

“Q1”, “Q2”, . . . , and “Q10” are affixed to the questions 54, 56, and 58 according to presentation order, which is order in which questions should be presented to a customer. The questions are presented in a form that can be answered with a degree such as “Did the receptionist speak properly?”.

In the answer options 55, 57, and 59, very satisfied “5”, almost satisfied “4”, fair “3”, somewhat dissatisfied “2”, and very dissatisfied “1” are displayed side by side. The answer options 55, 57, and 59 are common to all the questions 54, 56, and 58. The customer selects an arbitrary one of the five numbers (by, for example, pressing a button inscribed with a number) and answers the questions.

A sequential answer screen 42 shown in FIG. 3 is a screen of a form in which only one pair of a question and an answer option is displayed. According to the presentation order, first, the question “Q1” and the answer options for the question are displayed (FIG. 3(a)). When the customer ends an answer to “Q1” and presses a “proceed to the next question” button 67, the screen transitions to FIG. 3(b). On the sequential answer screen 42 in FIG. 3(b), the question “Q2” and the answer option related to the next presentation order is displayed. When the customer ends an answer to “Q2” and presses the “proceed to the next question” button 67, the screen transitions to a sequential answer screen for “Q3” related to the next presentation order (hereinafter the same shall apply).

In the questionnaire creation supporting system 1 according to this embodiment, whichever of the list answer screen 41 and the sequential answer screen 42 may be displayed. However, in one questionnaire opportunity, for example, when the question “Q2” and the subsequent questions are dynamically changed according to an answer to “Q1”, the sequential answer screen 42 is displayed (explained in detail below).

Setting Information

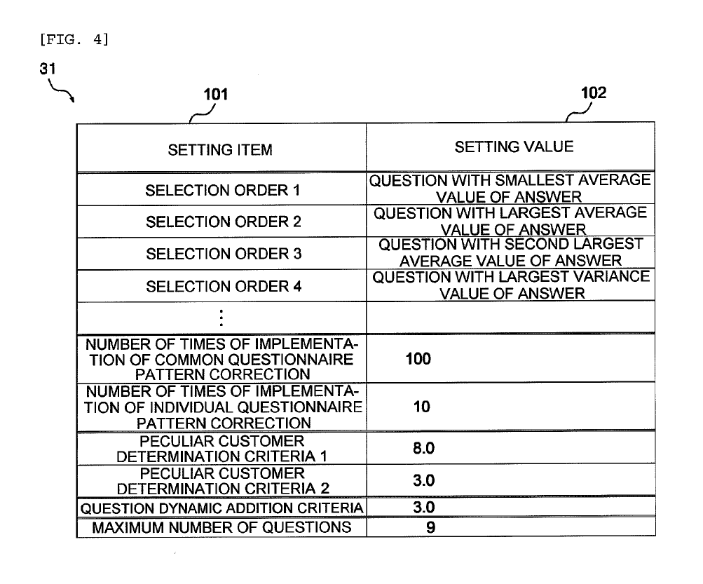

In the setting information 31 in FIG. 4, setting values are stored in a setting value column 102 in association with setting items stored in a setting item column 101.

Among setting items, “Selection order 1”, “selection order 2”, “selection order 3”, “selection order 4”, and the like in the setting item indicate a sequence of questions in which a method of questioning should be delved more specifically (into lower-order concepts).

In a questionnaire, it is possible to repeat the same question and acquire an average value and a variance value concerning numerical values “1” to “5” selected every time the question is repeated. As the average value is larger, the degree of satisfaction of a customer is higher. As the variance value is larger, the degree of satisfaction of the customer is more unstable.

A setting value corresponding to the setting item “selection order 1” is a “question with a smallest average value of answer”. A setting value corresponding to the setting item “selection order 2” is a “question with a largest average value of answer”. A setting value corresponding to the setting item “selection order 3” is a “question with a second smallest average value of answer”. A setting value corresponding to the setting item “selection order 4” is a “question with a largest variance value of an answer”. It is seen from the above that, in order of (1) a question with a lowest degree of satisfaction, (2) a question with a highest degree of satisfaction, (3) a question with a second lowest degree of satisfaction, and (4) a question with a most unstable degree of satisfaction, the questionnaire implementer attempts to present another question further delved with respect to the question in order to identify reasons for the evaluations.

Among the setting items, “number of times of implementation of common questionnaire pattern correction” and “number of times of implementation of individual questionnaire pattern correction” are limits of the number of times a common (or individual) questionnaire pattern explained below are continuously implemented. Unless a questionnaire with fixed questions is repeatedly implemented, it is difficult to learn a significant answer tendency of the customer. However, it is disadvantageous in terms of customer service to repeatedly implement the questionnaire with fixed questions more than necessary. That is, the “number of times of implementation of common (or individual) questionnaire pattern correction” indicates the number of times of implementation of a questionnaire, which is a reference for replacing a part of a plurality of questions (explained in detail below).

The above explanation is based on the premise that one kind of setting information 31 is used for all customers. However, as the setting information 31, setting information of a customer may be stored in the auxiliary storage device 13 in association with a customer ID of the customer. For example, different kinds of setting information 31 may be stored in association with applications provided to customers or in association with attributes (a beginner, an expert, etc.) of the customers. In this case, the questionnaire implementing apparatus 2 specifies the setting information 31 for a customer on the basis of an input customer ID of the customer. Further, a table in which applications provided to customers, attributes of the customers, and the like are stored in association with customer IDs of the customers is stored in the auxiliary storage device 13. The questionnaire implementing apparatus 2 specifies, on the basis of an input customer ID of a customer, the setting information 31 for an application provided to the customer or the setting information 31 for an attribute of the customer.

A questionnaire pattern is a concept that indicates which question is presented in which presentation order. As types of the questionnaire pattern, there are an “individual questionnaire pattern” customized for a specific customer and a “common questionnaire pattern” not particularly targeting a specific customer such as an initial questionnaire.

Among the setting items, “distinctive customer determination criteria 1” and “distinctive customer determination criteria 2” are thresholds (the number of times of implementation of a questionnaire up to a point of determination) in determining that, for a customer for whom a questionnaire is implemented on the basis of the “common questionnaire pattern”, a questionnaire is implemented in future on the basis of the “individual questionnaire pattern”.

It is assumed that a present questionnaire pattern includes questions 1, 2, 3, . . . , and N.

cₙ: an average value of answers of a certain customer in the past for a question n
c: an average value of c₁, c₂, c₃, etc.
aₙ: an average value of answers of all customers in the past to the question n
a: an average value of a₁, a₂, a₃, etc.
N: a total number of questions of the present questionnaire

Two values are defined according to Expressions 1 and 2 below.

(Σ((cₙ−c)−(aₙ−a))²)/N (Expression 1)

where, n=1, 2, 3, . . . , and N

|(cₙ−c)−(aₙ−a)| (Expression 2)

A value of Expression 1 is a value for defining, for all questions, a degree of deviation answers of the certain customer in the past from answers of all the customers in the past. On the other hand, a value of Expression 2 is a value for defining, for individual questions, a degree of deviation answers of the certain customer in the past from answers of all the customers in the past.

A threshold for the value defined by Expression 1 is the “distinctive customer determination criteria 1”. A threshold for the value defined by Expression 2 is the “distinctive customer determination criteria 2”.

In Expressions 1 and 2, a portion of “(cₙ−c)−(aₙ−a)” is not simply represented as “cₙ−aₙ”. This is for excluding subjectivity of the customers by deducting “c” and “a” respectively from “cₙ” and “aₙ”.

It is determined that the certain customer is distinctive according to a condition 1 or a condition 2.

(Condition 1) The value of Expression 1 is equal to or larger than the threshold.

(Condition 2) There is a question for which the value of Expression 2 is equal to or larger than the threshold.

The condition 2 is prepared because accurate determination cannot be sufficiently made only with the condition 1. For example, in FIG. 15, attention is paid to a customer r. Answers of the customer r are close to averages of all customers concerning most of questions. However, concerning a question 4, an answer of the customer r deviates from an average of all customers. In such a case, according to the condition 1, the customer r fails to be determined as a distinctive customer. According to the condition 2, the customer r can be determined as a distinctive customer.

As explained above, in a questionnaire implemented using the sequential answer screen 42, when an answer to a specific question by a certain customer is significantly different from answers in the past to the question by the customer, a question different from a planned question is sometimes displayed on the next sequential answer screen 42. Among the setting items, “question dynamic addition criteria” is a threshold of the difference.

Among the setting items, a “maximum number of questions” is a maximum number of questions included in one questionnaire.

Question Information

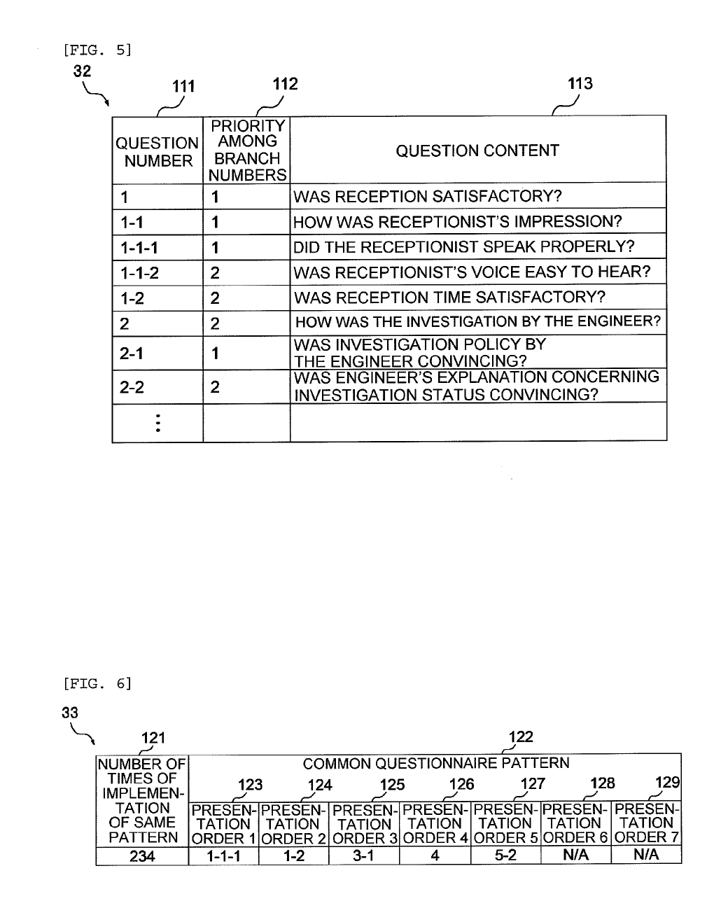

In the question information 32 in FIG. 5, priority among branch numbers is stored in a priority among branch number column 112 and a question is stored in a question content column 113 in association with a question number stored in a question number column 111.

The question number in the question number column 111 is an identifier for uniquely identifying the question. The question number has a form of a permutation of one or a plurality of numbers arranged in a plurality of relative positions that indicate layers. For example, a question “1-1” and a question “1-2” are present in a layer immediately under a question “1”. Further, a question “1-1-1” and a question “1-1-2” are present in a layer immediately under the question “1-1”. A question is subdivided into two in every lower-order layer. However, this is only an example. The question may be subdivided into, for example, three or more.

The priority among branch numbers of the priority of branch number column 112 is preferential order that indicates, when a plurality of questions in the same layer are present, which question among the questions should be presented first. The “questions in the same layer” means a plurality of questions without any higher-order question or a plurality of questions, one or a plurality of higher-order questions of which are all common. For example, in FIG. 5, questions with question numbers “1” and “2” are the “questions in the same layer”. Priorities among branch numbers of the questions are respectively “1” and “2”. Therefore, the question with the question number “1” is presented earlier than the question with the question number “2”. Questions with question numbers “1-1” and “1-2” are also the “questions in the same layer”. Priorities among branch numbers of the questions are respectively “1” and “2”. Therefore, the question with the question number “1-1” is presented earlier than the question with the question number “1-2”.

The question in the question content column 113 is wording of a question from the questionnaire implementer to a customer. As explained above, the question is presented in a form that can be answered with the options of answers that indicate the degree of satisfaction “1” to “5”. A lower-order question is more specific. For example, a question “1” asks about “reception”. A question “1-1” asks about finer “impression” in the “reception”. Similarly, a question “1-2” asks about finer “time” different from “impression” in the “reception”.

Common Questionnaire Information

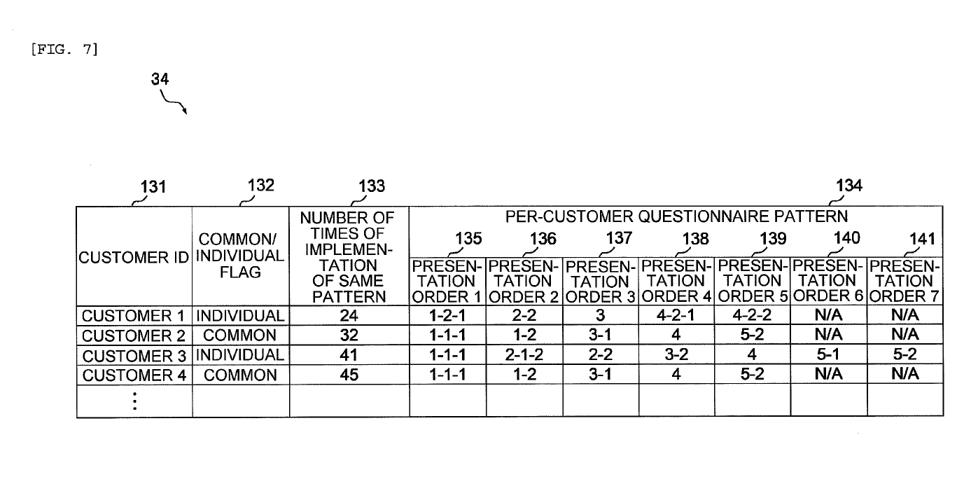

The common questionnaire information 33 in FIG. 6 defines a common questionnaire pattern. In a number of times of implementation of same pattern column 121, the number of times the common questionnaire pattern is implemented is stored.

In a presentation order 1 column 123, a presentation order 2 column 124, . . . , and a presentation order 7 column 129, which are sub-columns of a common questionnaire pattern column 122, question numbers of questions presented in the presentation orders are stored. It is seen from FIG. 6 that a common questionnaire pattern for presenting ‘presenting a question “1-1-1” in presentation order 1, a question “1-2 is presented next in presentation order 2, a question “3-1” is presented next in presentation order 3, a question “4” is presented next in presentation order 4, and a question “5-2” is presented next in presentation order 5’ is defined. It is also seen that the common questionnaire pattern is already implemented “234” times for customers.

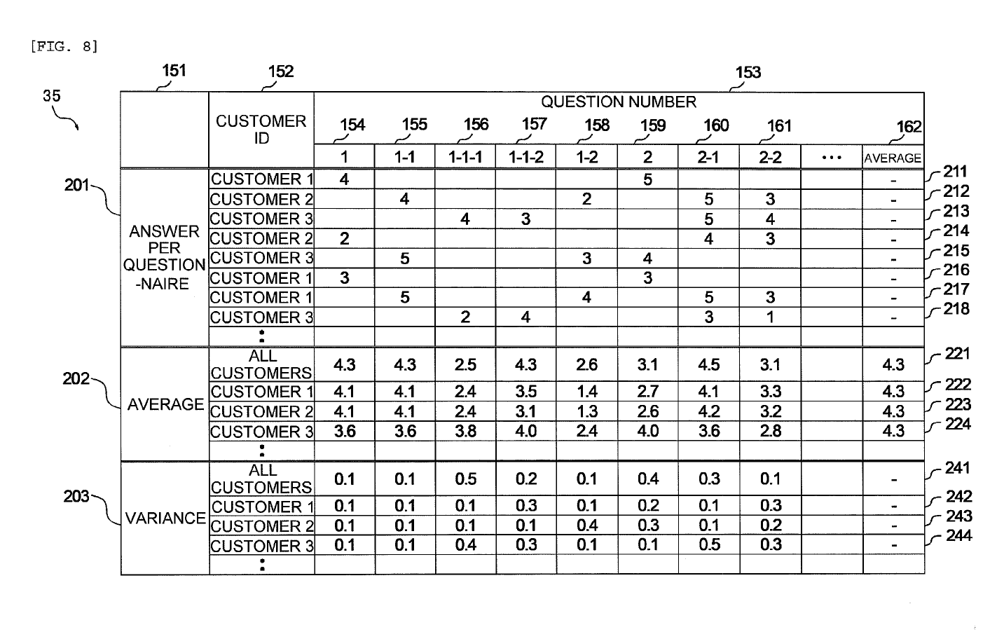

In FIG. 6, only the sub-columns to the presentation order 7 column 129 are shown. However, a presentation order 8 column, a presentation order 9 column, and the like may be increased to the right side. “N/A” indicates that a question corresponding to presentation order of a column with “N/A” is absent (the same holds true in FIG. 7).

Per-customer questionnaire information

In the per-customer questionnaire information 34 in FIG. 7, a common/individual flag is stored in a common/individual flag column 132, the number of times of implementation of same pattern is stored in a number of times of implementation of same patter column 133, and a per-customer questionnaire pattern is stored in a per-customer questionnaire pattern column 134 in association with a customer ID stored in a customer ID column 131.

The customer ID in the customer ID column 131 is an identifier for uniquely identifying a customer who answers a questionnaire.

The common/individual flag in the common/individual flag column 132 is any one of “common” that indicates that a questionnaire is performed for the customer on the basis of the “common questionnaire pattern” (see FIG. 6) and “individual” that indicates that a questionnaire is performed for the customer on the basis of an “individual questionnaire pattern” customized for the customer. The “per-customer questionnaire pattern” and the “individual questionnaire pattern” are different concepts. The “per-customer questionnaire pattern” is the “common questionnaire pattern” in some cases and is the “individual questionnaire pattern” in other cases.

The number of times of implementation of same pattern in the number of times of implementation of same pattern column 133 is a number that indicates, on the basis of the “common questionnaire pattern” or the “individual questionnaire pattern”, how many times the customer answered questionnaire in the past.

In a presentation order 1 column 135, a presentation order 2 column 136, . . . , and a presentation order 7 column 141, which are sub-columns of the per-customer questionnaire pattern column 134, question numbers of questions presented in the presentation orders are stored.

It is seen from a record in a first row in FIG. 7 that ‘an individual questionnaire pattern for, to a “customer 1”, a question “1-2-1” is presented in the presentation order 1, a question “2-2” is presented next in the presentation order 2, a question “3” is presented next in the presentation order 3, a question “4-2-1” is presented next in the presentation order 4, and a question “4-2-2” is presented next in the presentation order 5 is defined and a questionnaire is already implemented twenty-four times on the basis of the individual questionnaire pattern’.

The number of records of the per-customer questionnaire information 34 is equal to the number of customers.

It is seen from records in a second row and a fourth row in FIG. 7 that ‘a common questionnaire pattern (same as FIG. 6) for, to a “customer 2” and a “customer 4”, a question “1-1-1” is presented in the presentation order 1, a question “1-2” is presented next in the presentation order 2, a question “3-1” is presented next in the presentation order 3, a question “4” is presented next in the presentation order 4, and a question “5-2” is presented next in the presentation order 5 is applied and a questionnaire is already implemented thirty-two times for the “customer 2” and forty-five times for the “customer 4” on the basis of the common questionnaire pattern’.

Answer Data Information

Answer information in FIG. 8 is, as a whole, a matrix in which question numbers are arrayed on the abscissa (sub-columns 154 to 161 of a question number column 153) and customer IDs are arrayed on the ordinate (rows 211 to 244). The question numbers on the abscissa (the sub-columns 154 to 161) are the same as the question numbers in FIG. 5. Sub-columns corresponding to prepared all questions are provided.

In a section 201 of “answer per questionnaire”, an answer (any one of numerical values “1” to “5”) selected by a customer on the ordinate in the past in response to a question of a question number on the abscissa in the past is stored in a cell at an intersection of the ordinate and the abscissa. Each of rows of the section 201 corresponds to one implementation of a questionnaire. The rows are stored in time series from up to down. Blank cells are present because the question is not included in the questionnaire at that point.

The number of rows of the section 201 coincides with a cumulative total number of customers who receives the questionnaire.

In a section 202 of “average”, an average value of an answer (any one of the numerical values “1” to “5”) selected by a customer on the ordinate in response to a question of a question number on the abscissa in the past is stored in a cell of an intersection of the ordinate and the abscissa. For example, in the row 222, an average value calculated for each of question numbers by totaling the row 211, the row 216, the row 217, etc., which are rows concerning the “customer 1”, among rows belonging to the section 201 is stored. The same holds true concerning the row 223 and the row 224. In the row 221, an average calculated for each of question numbers by totaling all the rows belonging to the section 201 (an average value concerning all customers) is stored. In an average column 162 of the section 202, an average of values of the sub-columns 154 to 161 is stored.

In a section 203 of “variance”, a variance value of an answer (any one of the numerical values “1” to “5”) selected by a customer on the ordinate in response to a question of a question number on the abscissa in the past is stored in a cell of an intersection of the ordinate and the abscissa. In the row 242, a variance value calculated for each of question numbers by totaling the row 211, the row 216, the row 217, etc., which are the rows concerning the “customer 1” among the rows belonging to the section 201, is stored. The same holds true concerning rows 243 and 244.

In the row 241, a variance value calculated for each of the question numbers by totaling all the rows belonging to the section 201 (a variance value concerning all the customers) is stored.

The “average value” and the “variance value” are concepts equivalent to a “representative value of numerical values of answers” but are only examples of the concepts. For example, a value indicating the size of a numerical value group such as a median value or a mode value may substitute the “average value”. A value indicating dispersion of a numerical value group such as a standard deviation may substitute the “variance value”.

Questionnaire Pattern Transition Information

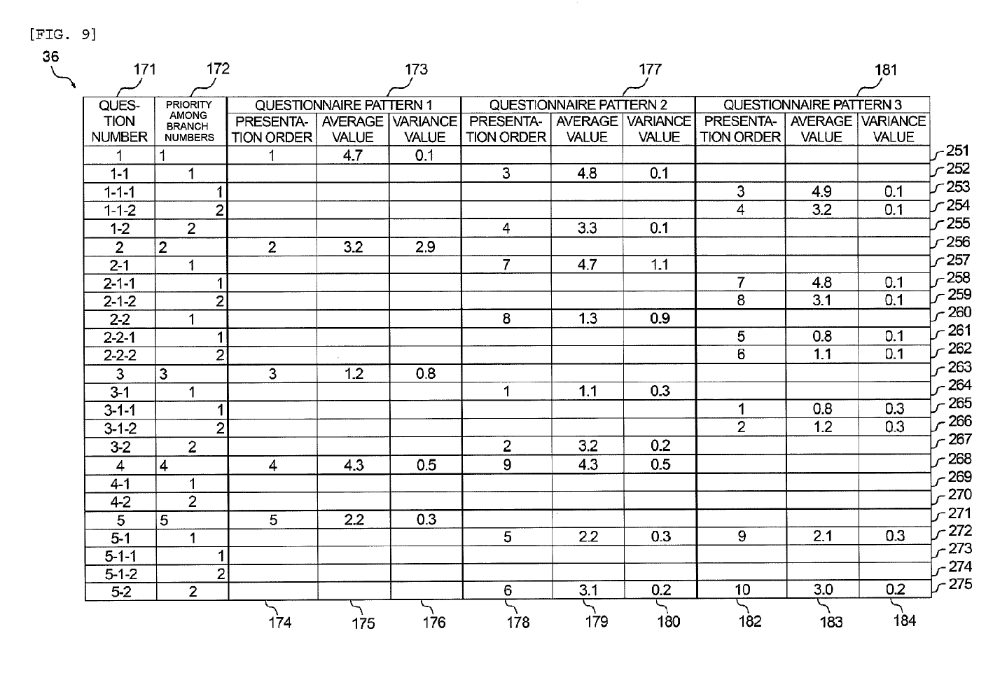

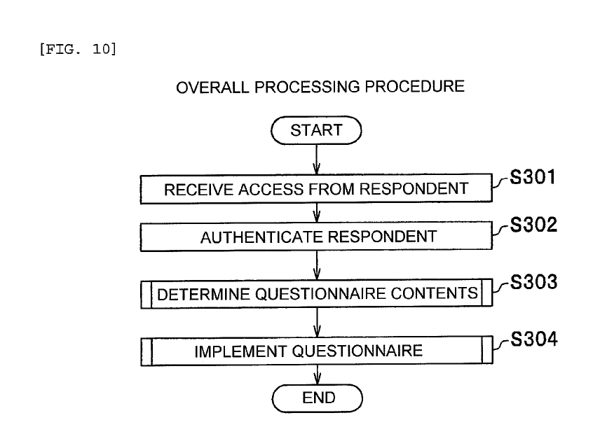

Processing for creating a new questionnaire pattern on the basis of a certain existing questionnaire pattern is explained along questionnaire transition information in FIG. 9. “Existing” and “new” are words indicating whether a questionnaire pattern is used or not used in a questionnaire in the past irrespective of whether the questionnaire pattern is the “common questionnaire pattern” or the “individual questionnaire pattern”.

A question number column 171 and a priority among branch numbers column 172 of the questionnaire pattern transition information 36 are as explained with reference to FIG. 5. Question numbers concerning prepared all questions are stored in the question number column 171.

Concerning columns 173, 177, and 181, only a questionnaire pattern 1 column 173 is present in the beginning. Then, a questionnaire pattern 2 column 177 is created on the basis of the questionnaire pattern 1 column 173 and a questionnaire pattern 3 column 181 is created on the basis of the questionnaire pattern 2 column 177. In this way, FIG. 9 is gradually extended in the right direction (explained in detail below).

In the questionnaire pattern 1 column 173, a presentation order column 174, an average value column 175, and a variance value column 176 are present as sub-columns. The same holds true concerning the questionnaire pattern 2 column 177 and the questionnaire pattern 3 column 181.

One kind of the questionnaire pattern transition information 36 is present for each of customer IDs and stored in the auxiliary storage device 13 in association with the customer ID. Separately from the questionnaire pattern transition information 36, one kind of the questionnaire pattern transition information 36 is present for the “common questionnaire pattern” and stored in the auxiliary storage device 13.

Overview 1 of New Questionnaire Pattern Creation

In the following explanation, processing for creating a new questionnaire pattern (a questionnaire pattern 2 in FIG. 9) on the basis of an existing questionnaire pattern (a questionnaire pattern 1 in FIG. 9) is explained. The processing is separately explained in explanation of flowcharts.

As premises of the explanation, (1) in the setting item of the setting information 31 in FIG. 4, the selection order 1, the selection order 2, the selection order 3, and the selection order 4 are present. Setting values for the selection orders are as shown in FIG. 4. A maximum number of questions is “9”.

(2) In the per-customer questionnaire information 34 in FIG. 7, the per-customer questionnaire pattern column 134 of a record concerning a customer X indicates that ‘a question number is “1” concerning the presentation order 1, a question number is “2” concerning the presentation order 2, a question number is “3” concerning the presentation order 3, a question number is “4” concerning the presentation order 4, and a question number is “5” concerning the presentation order 5’.

(3) In the section 202 of the answer information 35 in FIG. 8, an average value of the customer X is “4.7” concerning the question number “1”, “3.2” concerning the question number “2”, “1.2” concerning a question number “3”, “4.3” concerning a question number “4”, and “2.2” concerning a question number

(4) In the section 203 of the answer information 35 in FIG. 8, a variance value of the customer X is “0.1” concerning the question number “1”, “2.9” concerning the question number “2”, “0.8” concerning the question number “3”, “0.5” concerning the question number “4”, and “0.3” concerning the question number “5”.

(5) The contents of the premises (2), (3), and (4) are stored in the questionnaire pattern 1 column 173 of the questionnaire pattern transition information 36 (FIG. 9) associated with the customer X.

The new-questionnaire-pattern creating unit 23 acquires a setting value corresponding to the setting item “selection order 1” in FIG. 4. The acquired setting value is “a question with a smallest average value of answer”.

The new-questionnaire-pattern creating unit 23 searches for a smallest value among average values in the average value column 175 in FIG. 9. As a search result, “1.2” in a row 263 is relevant. A question number corresponding to the relevant average value is “3” (the question number column 171 in the row 263).

The new-questionnaire-pattern creating unit 23 searches for a question number present in a layer under the question number “3”. As a search result, a question number “3-1” (a row 264) and a question number “3-2” (a row 267) are relevant. Priority among branch numbers of the relevant two question numbers is “1” concerning the question number “3-1” and is “2” concerning the question number “3-2” (the priority among branch numbers column 172).

The new-questionnaire-pattern creating unit 23 creates the questionnaire pattern 2 column 177 anew, stores “1” in the row 264 of a presentation order column 178, and stores “2” in the row 267 of the presentation order column 178.

The new-questionnaire-pattern creating unit 23 acquires a setting value corresponding to the setting item “selection order 2” in FIG. 4. The acquired setting value is “a question with a largest average value of answer”.

The new-questionnaire-pattern creating unit 23 searches for a largest value among the average values in the average value column 175 in FIG. 9. As a search result, “4.7” in a row 251 is relevant. A question number corresponding to the relevant average value is “1” (the question number column 171 in the row 251).

The new-questionnaire-pattern creating unit 23 searches for a question number is a layer under the question number “1”. As a search result, the question number “1-1” (a row 252) and the question number “1-2” (a row 255) are relevant. Priority among branch numbers of the relevant two question numbers is “1” concerning the question number “1-1” and “2” concerning the question number “1-2” (the priority among branch numbers column 172).

The new-questionnaire-pattern creating unit 23 stores “3” in the row 252 of the presentation order column 178 and stores “4” in the row 255 of the presentation order column 178 of the created questionnaire pattern 2 column 177.

The new-questionnaire-pattern creating unit 23 acquires a setting value corresponding to the setting item “selection order 3” in FIG. 4. The acquired setting value is “a question with a second smallest average value of answer”.

The new-questionnaire-pattern creating unit 23 searches for a second smallest value among the average values in the average value column 175 in FIG. 9. As a search result, “2.2” in a row 271 is relevant. A question number corresponding to the relevant average value is “5” (the question number column 171 in the row 271).

The new-questionnaire-pattern creating unit 23 searches for a question number present in a layer under the question number “5”. As a search result, a question number “5-1” (a row 272) and a question number “5-2” (a row 275) are relevant. Priority among branch numbers of the relevant two question numbers is “1” concerning the question number “5-1” and is “2” concerning the question number “5-2” (the priority among branch numbers column 172).

The new-questionnaire-pattern creating unit 23 stores “5” in the row 272 of the presentation order column 178 and stores “6” in the row 275 of the presentation order column 178 of the created questionnaire pattern 2 column 177.

The new-questionnaire-pattern creating unit 23 acquires a setting value corresponding to the setting item “selection order 4” in FIG. 4. The acquired setting value is “a question with a largest variance value of answer”.

The new-questionnaire-pattern creating unit 23 searches for a largest value among the variance values in the variance value column 176 in FIG. 9. As a search result, “2.9” in a row 256 is relevant. A question number corresponding to the relevant variance value is “2” (the question number column 171 in the row 256).

The new-questionnaire-pattern creating unit 23 searches for a question number present in a layer under the question number “2”. As a search result, a question number “2-1” (a row 257) and a question number “2-2” (a row 260) are relevant. Priority among branch numbers of the relevant two question numbers is “1” concerning the question number “2-1” and is “2” concerning the question number “2-2” (the priority among branch numbers column 172)

The new-questionnaire-pattern creating unit 23 stores “7” in the row 257 of the presentation order column 178 and stores “8” in the row 260 of the presentation order column 178 of the created questionnaire pattern 2 column 177.

At this stage, lower-order questions are determined taking into account all the selection orders 1 to 4 of the setting item. However, the number of questions in the questionnaire pattern 2 is “8” at the present point and does not reach the maximum number of questions “9”. That is, only one more question can be added.

The new-questionnaire-pattern creating unit 23 searches for, in the questionnaire pattern 1, one question in order from a question with smallest presentation order in the questionnaire pattern 1 out of question numbers not determined as being included in the questionnaire pattern 2 or question numbers having a highest-order layer in common with the question numbers and not determined as being included in the questionnaire pattern 2. Only the question number “4” is present as the question numbers that are not determined as being included in the questionnaire pattern 2 or the question numbers having a highest-order layer in common with which are not determined as being included in the questionnaire pattern 2. As a search result, the question number “4” (a row 268) is relevant.

The new-questionnaire-pattern creating unit 23 stores “9” in the row 268 of the presentation order column 178 of the created questionnaire pattern 2 column 177.

In the processing explained above, a new questionnaire pattern is completed. The new questionnaire pattern is represented as the presentation orders stored in the presentation order column 178 in FIG. 9 and the question numbers in the question number column 171 corresponding to the presentation orders.

Overview 2 of the New Questionnaire Pattern Creation

In the following explanation, processing for creating a new questionnaire pattern (a questionnaire pattern 3 in FIG. 9) on the basis of the existing questionnaire pattern (the questionnaire pattern 2 in FIG. 9) is explained. The processing is separately explained in the explanation of the flowcharts as well.

As premises of the explanation, (1) in the setting information 31 in FIG. 4, the selection order 1, the selection order 2, the selection order 3, and the selection order 4 are present. Setting values for the selection orders are as shown in FIG. 4. A maximum number of questions is “10”.

(2) In the per-customer questionnaire information 34 in FIG. 7, the per-customer questionnaire pattern column 134 of the record concerning the customer X indicates that ‘a question number is “3-1” concerning the presentation order 1, a question number is “3-2” concerning the presentation order 2, a question number is “1-1” concerning the presentation order 3, a question number is “1-2” concerning the presentation order 4, a question number is “5-1” concerning the presentation order 5, a question number is “5-2” concerning the presentation order 6, a question number is “2-1” concerning the presentation order 7, a question number is “2-2” concerning the presentation order 8, and a question number is “4” concerning the presentation order 9’.

(3) In the section 202 of the answer information 35 in FIG. 8, an average value of the customer X is “4.8” concerning the question number “1-1”, “3.3” concerning the question number “1-2”, “4.7” concerning the question number “2-1”, “1.3” concerning the question number “2-2”, “1.1” concerning the question number “3-1”, “3.2” concerning the question number “3-2”, “4.3” concerning the question number “4”, “2.2” concerning the question number “5-1”, and “3.1” concerning the question number “5-2”.

(4) In the section 203 of the answer information 35 in FIG. 8, a variance value of the customer X is “0.1” concerning the question number “1-1”, “0.1” concerning the question number “1-2”, “1.1” concerning the question number “2-1”, “0.9” concerning the question number “2-2”, “0.3” concerning the question number “3-1”, “0.2” concerning the question number “3-2”, “0.5” concerning the question number “4”, “0.3” concerning the question number “5-1”, and “0.2” concerning the question number “5-2”.

(5) The contents of the premises (2), (3), and (4) are stored in the questionnaire pattern 2 column 177 of the questionnaire pattern transition information 36 (FIG. 9) associated with the customer X.

The new-questionnaire-pattern creating unit 23 acquires a setting value corresponding to the setting item “selection order 1” in FIG. 4. The acquired setting value is “a question with a smallest average value of answer”.

The new-questionnaire-pattern creating unit 23 searches for a smallest value among average values in an average value column 179 in FIG. 9. As a search result, “1.1” in the row 264 is relevant. A question number corresponding to the relevant average value is “3-1” (the question number column 171 in the row 264).

The new-questionnaire-pattern creating unit 23 searches for a question number present in a layer under the question number “3-1”. As a search result, a question number “3-1-1” (a row 265) and a question number “3-1-2” (a row 266) are relevant. Priority among branch numbers of the relevant two question numbers is “1” concerning the question number “3-1-1” and is “2” concerning the question number “3-1-2” (the priority among branch numbers column 172).

The new-questionnaire-pattern creating unit 23 creates the questionnaire pattern 3 column 181 anew, stores “1” in the row 265 of a presentation order column 182, and stores “2” in the row 266 of the presentation order column 182.

The new-questionnaire-pattern creating unit 23 acquires a setting value corresponding to the setting item “selection order 2” in FIG. 4. The acquired setting value is “a question with a largest average value of answer”.

The new-questionnaire-pattern creating unit 23 searches for a largest value among the average values in the average value column 179 in FIG. 9. As a search result, “4.8” in the row 252 is relevant. A question number corresponding to the relevant average value is “1-1” (the question number column 171 in the row 252).

The new-questionnaire-pattern creating unit 23 searches for a question number is a layer under the question number “1-1”. As a search result, a question number “1-1-1” (a row 253) and a question number “1-1-2” (a row 254) are relevant. Priority among branch numbers of the relevant two question numbers is “1” concerning the question number “1-1-1” and “2” concerning the question number “1-1-2” (the priority among branch numbers column 172).

The new-questionnaire-pattern creating unit 23 stores “3” in the row 253 of the presentation order column 182 and stores “4” in the row 254 of the presentation order column 182 of the created questionnaire pattern 3 column 181.

The new-questionnaire-pattern creating unit 23 acquires a setting value corresponding to the setting item “selection order 3” in FIG. 4. The acquired setting value is “a question with a second smallest average value of answer”.

The new-questionnaire-pattern creating unit 23 searches for a second smallest value among the average values in the average value column 179 in FIG. 9. As a search result, “1.3” in the row 260 is relevant. A question number corresponding to the relevant average value is “2-2” (the question number column 171 in the row 260).

The new-questionnaire-pattern creating unit 23 searches for a question number present in a layer under the question number “2-2”. As a search result, a question number “2-2-1” (a row 261) and a question number “2-2-2” (a row 262) are relevant. Priority among branch numbers of the relevant two question numbers is “1” concerning the question number “2-2-1” and is “2” concerning the question number “2-2-2” (the priority among branch numbers column 172).

The new-questionnaire-pattern creating unit 23 stores “5” in the row 261 of the presentation order column 182 and stores “6” in the row 262 of the presentation order column 182 of the created questionnaire pattern 3 column 181.

The new-questionnaire-pattern creating unit 23 acquires a setting value corresponding to the setting item “selection order 4” in FIG. 4. The acquired setting value is “a question with a largest variance value of answer”.

The new-questionnaire-pattern creating unit 23 searches for a largest value among the variance values in a variance value column 180 in FIG. 9. As a search result, “1.1” in the row 257 is relevant. A question number corresponding to the relevant variance value is “2-1” (the question number column 171 in the row 257).

The new-questionnaire-pattern creating unit 23 searches for a question number present in a layer under the question number “2-1”. As a search result, a question number “2-1-1” (a row 258) and a question number “21-2” (a row 259) are relevant. Priority among branch numbers of the relevant two question numbers is “1” concerning the question number “2-1-1” and is “2” concerning the question number “2-1-2” (the priority among branch numbers column 172).

The new-questionnaire-pattern creating unit 23 stores “7” in the row 258 of the presentation order column 182 and stores “8” in the row 259 of the presentation order column 182 of the created questionnaire pattern 3 column 181.

At this stage, lower-order questions are determined taking into account all the selection orders 1 to 4 of the setting item. However, the number of questions in the questionnaire pattern 3 is “8” at the present point and does not reach the maximum number of questions “10”. That is, only two more questions can be added.

The new-questionnaire-pattern creating unit 23 searches for, in the questionnaire pattern 2, two questions in order from a question with smallest presentation order in the questionnaire pattern 2 out of question numbers not determined as being included in the questionnaire pattern 3 or question numbers having a highest-order layer in common with the question numbers and not determined as being included in the questionnaire pattern 3. The question number “4”, “5-1”, and “5-2” are present as the question numbers that are not determined as being included in the questionnaire pattern 3 or the question numbers having a highest-order layer in common with which are not determined as being included in the questionnaire pattern 3. Presentation orders of the question numbers in the questionnaire pattern 2 are respectively “9”, “5”, and “6”. As a search result, the question number “5-1” (the row 272) and the question number “5-2” (the row 275) are relevant.

The new-questionnaire-pattern creating unit 23 stores “9” in the row 272 of the presentation order column 182 and stores “10” in the row 275 of the presentation order column 182 of the created questionnaire pattern 3 column 181.

In the processing explained above, a new questionnaire pattern is completed. The new questionnaire pattern is represented as the presentation orders stored in the presentation order column 182 in FIG. 9 and the question numbers in the question number column 171 corresponding to the presentation orders.

Overall Processing Procedure

Overall processing procedure is explained with reference to FIG. 10.

In step S301, the questionnaire implementing unit 22 receives an access from a respondent. Specifically, the questionnaire implementing unit 22 receives a customer ID and a pass word input by a customer (a respondent) via the input device of the terminal apparatus for answering 3.

In step S302, the questionnaire implementing unit 22 authenticates the respondent. Specifically, the questionnaire implementing unit 22 searches through a table for authentication using, as a search key, a combination of the customer ID and the password received in step S301. The table for authentication is a table that associates customer IDs, customer names, and passwords with one another. The table for authentication is stored in the auxiliary storage device 13 (not shown in the figure). When a record including the combination of the received customer ID and the received password is absent, the questionnaire implementing unit 22 displays, on the output device of the terminal apparatus for answering 3, a screen for urging the customer to input the customer ID and the password again (the questionnaire implementing unit 22 repeats the display until the customer succeeds in the authentication.) The customer ID received and successfully authenticated is referred to as “target customer ID”.

In step S303, the questionnaire-content determining unit 21 determines questionnaire contents. Details of step S303 are explained below.

In step S304, the questionnaire implementing unit 22 implements a questionnaire. Details of step S304 are explained below.

Thereafter, the questionnaire implementing unit 22 ends the overall processing procedure.

Details of Step S303

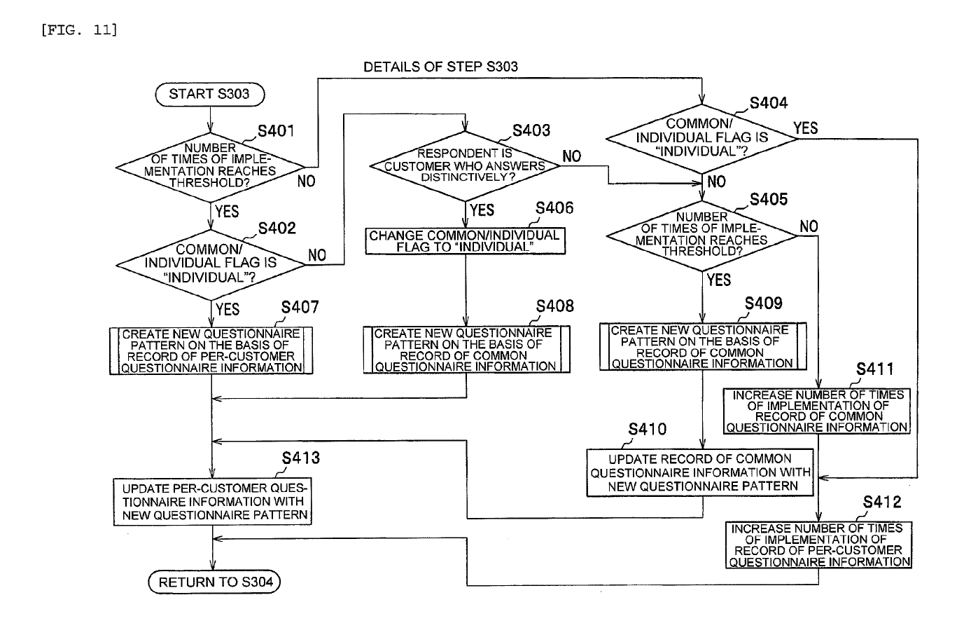

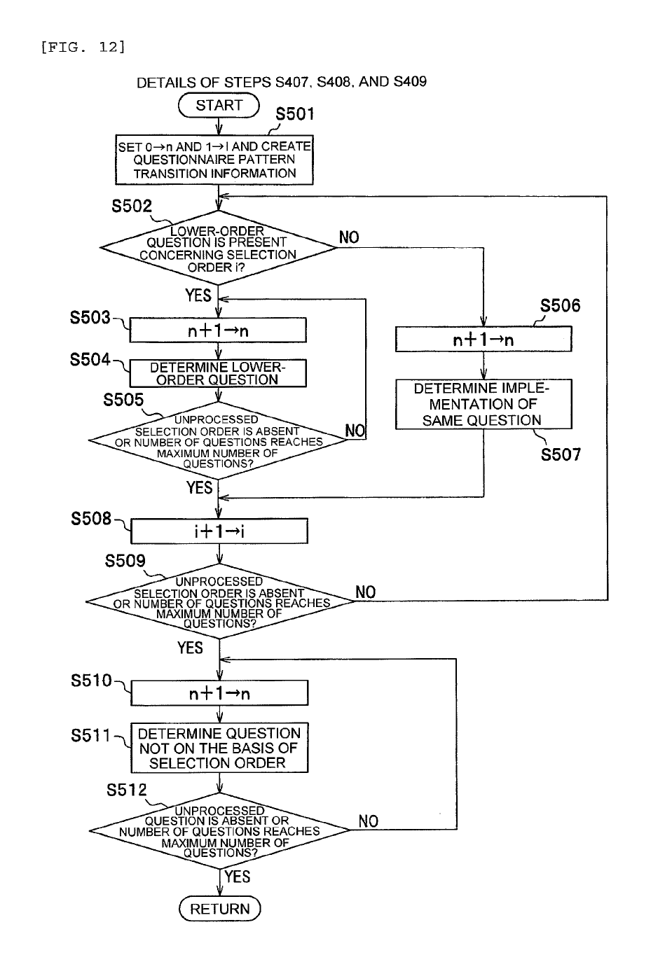

The details of step S303 is explained with reference to FIG. 11.

In step S401, the questionnaire-content determining unit 21 determines whether the number of times of implementation reaches a threshold. Specifically, the questionnaire-content determining unit 21 searches through the per-customer questionnaire information 34 (FIG. 7) using the target customer ID as a search key and acquires a relevant record (the relevant record is referred to as “target customer record”). The questionnaire-content determining unit 21 compares the number of times of implementation of same pattern of the target customer record and the setting value of the number of times of implementation of individual questionnaire pattern correction of the setting information (FIG. 4). When the acquired number of times of implementation of same pattern is equal to or larger than the setting value in the comparison (“YES” in step S401), the questionnaire-content determining unit 21 proceeds to step S402. Otherwise (“NO” in step S401), the questionnaire-content determining unit 21 proceeds to step S404.

In step S402, the questionnaire-content determining unit determines whether the common/individual flag is “individual”. Specifically, when the common/individual flag of the target customer record is “individual” (“YES” in step S402), the questionnaire-content determining unit 21 proceeds to step S407. Otherwise (“NO” in step S402), the questionnaire-content determining unit 21 proceeds to step S403.

In step S403, the questionnaire-content determining unit 21 determines whether the respondent is a customer who answers distinctively. Specifically, first, the questionnaire-content determining unit 21 acquires values (average values) of all the columns 154 to 161 and 162 in the row 221 of the answer information 35 (FIG. 8).

Second, the questionnaire-content determining unit 21 searches through the section 202 of the answer information 35 (FIG. 8) using the target customer ID as a search key and acquires values (average values) of all the columns 154 to 161 and 162 of a relevant record (row).

Third, the questionnaire-content determining unit 21 calculates a value of (Σ((cₙ−c)−(aₙ−a))²)/N (where, n=1, 2, 3, . . . , and N) using the acquired values (average values).

Fourth, the questionnaire-content determining unit 21 compares a calculation result and the setting value of the “distinctive customer determination criteria 1” of the setting information 31 (FIG. 4).

Fifth, when the calculation result is equal to or larger than the setting value as a result of the comparison (“YES in step S403), the questionnaire-content determining unit 21 proceeds to step S406. Otherwise (“NO” in step S403), the questionnaire-content determining unit 21 proceeds to step S405.

If the target customer ID is, for example, a “customer 1” in the “third”, cₙ is equivalent to the values of the columns 154 to 161 in the row 222 in FIG. 8, c is equivalent to the value in the average column 162 in the row 222 in FIG. 8, aₙ is equivalent to the values of the columns 154 to 161 in the row 221 in FIG. 8, and a is equivalent to the value in the average column 162 in the row 221 in FIG. 8.

“Third”, “fourth”, and “fifth” of step S403 may be substituted by processing explained in quotation marks ‘ ’ below.

‘Third, the questionnaire-content determining unit 21 calculates a value of |(cₙ−c)−(aₙ−a)| using the acquired value (average value). Calculation results are obtained for the number of question numbers in FIG. 8.

If the customer ID is, for example, the “customer 1”, cₙ is equivalent to values of the columns 154 to 161 in the row 222 in FIG. 8, c is equivalent to the value in the average column 162 in the row 222 in FIG. 8, aₙ is equivalent to the values of the columns 154 to 161 in the row 221 in FIG. 8, and a is equivalent to the value in the average column 162 in the row 221 in FIG. 8.

Fourth, the questionnaire-content determining unit 21 compares a largest value among the calculation results and the setting value of the “distinctive customer determination criteria 2” of the setting information 31 (FIG. 4).

Fifth, when the largest value among the calculation results is equal to or larger than the setting value as a result of the comparison (“YES” in step S403), the questionnaire-content determining unit 21 proceeds to step S406. Otherwise (“NO” in step S403), the questionnaire-content determining unit 21 proceeds to step S405.’

In step S404, the questionnaire-content determining unit determines whether the common/individual flag is “individual”. Specifically, when the common/individual flag of the target customer record is “individual” (“YES” in step S404), the questionnaire-content determining unit 21 proceeds to step S412. Otherwise (“NO” in step S404), the questionnaire-content determining unit 21 proceeds to step S405.

In step S405, the questionnaire-content determining unit 21 determines whether the number of times of implementation reaches the threshold. Specifically, the questionnaire-content determining unit 21 acquires the number of times of implementation of same pattern of the common questionnaire information 33 (FIG. 6). the questionnaire-content determining unit 21 compares the acquired number of times of implementation of same pattern and the setting value of the number of times of implementation of common questionnaire pattern correction of the setting information (FIG. 4). When the acquired number of times of implementation of same pattern is equal to or larger than the setting value in the comparison (“YES” in step S405), the questionnaire-content determining unit 21 proceeds to step S409. Otherwise (“NO” in step S405), the questionnaire-content determining unit 21 proceeds to step S411.

In step S406, the questionnaire-content determining unit 21 the questionnaire-content determining unit 21 changes the common/individual flag to “individual”. Specifically, the questionnaire-content determining unit 21 changes the common/individual flag of the target customer record to “individual”.

In steps S407, S408, and S409, the questionnaire-content determining unit 21 creates a new questionnaire pattern on the basis of the record of the per-customer (common) questionnaire information. Since kinds of processing in these steps are similar to one another, details of the processing are collectively explained below. As explained in the explanation of the questionnaire pattern transition information (FIG. 9), these steps are the processing for receiving the input of an existing questionnaire pattern and outputting a new questionnaire pattern.

In step S410, the questionnaire-content determining unit 21 updates the record of the common questionnaire information with the new questionnaire pattern. Specifically, the questionnaire-content determining unit 21 stores question numbers in the columns 123 to 129 of the common questionnaire information 33 (FIG. 6) according to presentation orders of the new questionnaire pattern created in step S409.

In step S411, the questionnaire-content determining unit 21 increases the number of times of implementation of the record of the common questionnaire information. Specifically, the questionnaire-content determining unit 21 adds 1 to the number of times of implementation of same pattern of the common questionnaire information 33 (FIG. 6) and overwrites the common questionnaire information 33.

In step S412, the questionnaire-content determining unit 21 increases the number of times of implementation of the record of the per-customer questionnaire information. Specifically, the questionnaire-content determining unit 21 adds 1 to the number of times of implementation of same pattern of the target customer record and overwrites the target customer record.

In step S413, the questionnaire-content determining unit 21 updates the record of the per-customer questionnaire information with the new questionnaire pattern. Specifically, the questionnaire-content determining unit 21 stores question numbers in the columns 135 to 141 of the target customer record according to the presentation orders of the new questionnaire pattern created in step S407, S408, or S409. Thereafter, the questionnaire-content determining unit 21 returns to step S304.

Details of steps S407, S408, and S409

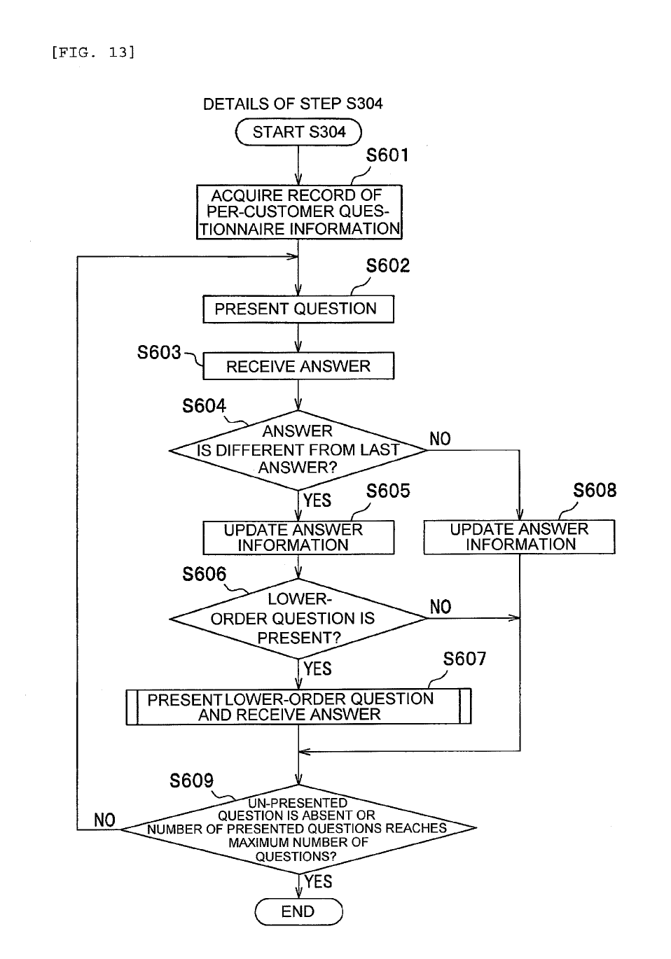

Details of steps S407, S408, and S409 are explained with reference to FIG. 12.

In step S501, the questionnaire-content determining unit sets 0→n and 1→i and creates questionnaire pattern transition information. Specifically, first, the questionnaire-content determining unit 21 substitutes 0 in the variable “n” and substitutes 1 in the variable “i”. Incidentally, “n” indicates the number and the presentation order of questions simultaneously and “i” indicates the selection order of the questions.

Second, the questionnaire-content determining unit 21 acquires the per-customer questionnaire pattern (presentation order and question numbers corresponding to the presentation order) of the target customer record from the per-customer questionnaire information 34 (FIG. 7). The questionnaire-content determining unit 21 acquires an average value of responses of the record (the row) including the target customer ID from the section 202 of the answer information 35 (FIG. 8).

Third, in the questionnaire pattern transition information 36 (FIG. 9) associated with the target customer ID, the questionnaire-content determining unit 21 creates the questionnaire pattern 1 column 173 anew and transfers the information acquired in “second” to the questionnaire pattern 1 column 173.

In step S502, the new-questionnaire-pattern creating unit 23 determines whether a lower-order question is present concerning selection order i. For convenience of explanation, in the following explanation, it is assumed that “i=1” currently. Specifically, first, the new-questionnaire-pattern creating unit 23 searches through the setting information 31 (FIG. 4) using the “selection order 1” as a search key and acquires a setting value of a relevant record. A “question with a smallest average value of answer” is acquired.

Second, in the questionnaire pattern transition information 36, the new-questionnaire-pattern creating unit 23 searches for a record (a row) with a smallest value in the average value column 175. In the example in FIG. 9, since a smallest value among the values stored in the average value column 175 is “1.2”, the row 263 is relevant. The new-questionnaire-pattern creating unit 23 specifies a question number corresponding to the average value. In this case, the question number “3” (the row 263 of the question number column 171) is specified for “1.2”.

Third, in the questionnaire pattern transition information 36, the new-questionnaire-pattern creating unit 23 searches for question numbers belonging to a lower-order layer of the specified question number. In this case, the question number “3-1” (the row 264) and the question number “3-2” (the row 267) are relevant.

Fourth, when the relevant question numbers are present in “third” (“YES” in step S502), the new-questionnaire-pattern creating unit 23 proceeds to step S503 while retaining all the relevant question numbers. Otherwise (“NO” in step S502), the new-questionnaire-pattern creating unit 23 proceeds to step S506.

In step S503, the new-questionnaire-pattern creating unit 23 set n+1→n. Specifically, the new-questionnaire-pattern creating unit 23 adds 1 to the variable “n”. For convenience of explanation, in the following explanation, it is assumed that “n=1” after the step.

In step S504, the new-questionnaire-pattern creating unit 23 determines a lower-order question. Specifically, the new-questionnaire-pattern creating unit 23 determines, as a question number with presentation order n, a question number with highest priority among branch numbers (with a smallest number) among the question numbers retained in step S502. The priority among branch numbers of the question number “3-1” is “1” (the row 264 of the priority among branch numbers column 172) and the priority among branch numbers of the question number “3-2” is “2” (the row 267 of the priority among branch numbers 172). In this example, the question number “3-1” is determined as a question number with the presentation order 1.

Second, in the questionnaire pattern transition information 36 (FIG. 9), the new-questionnaire-pattern creating unit 23 creates the questionnaire pattern 2 column 177 anew and stores “n” in a row having the question number determined in “first” of the presentation order column 178 of the questionnaire pattern 2 column 177. In this example, the new-questionnaire-pattern creating unit 23 stores “1” in the row 264 of the presentation order column 178.

In step S505, the new-questionnaire-pattern creating unit 23 determines whether an unprocessed lower-order question is absent or the number of questions reaches the maximum number of questions. Specifically, first, the new-questionnaire-pattern creating unit 23 a question number not determined as a lower-order question number in step S504 is present among the question numbers retained in step S502.

Second, the new-questionnaire-pattern creating unit 23 determines whether “n” is equal to or larger than a setting value corresponding to the setting item “maximum number of questions” of the setting information 31 (FIG. 4). In the following explanation, it is assumed that the setting value corresponding to the “maximum number of questions” is “9”.

Third, when a determination result in “first” is “absent” or a determination result in “second” is “equal to or larger than the setting value” (“YES” in step S505), the new-questionnaire-pattern creating unit 23 proceeds to step S508. Otherwise (“NO” in step S505), the new-questionnaire-pattern creating unit 23 returns to step S503. In this example, the determination result in “first” is ‘the question number “3-2” is present’ and the determination result in “second” is “not equal to or larger than the setting value” (n=1<9 (setting value)). Therefore, the new-questionnaire-pattern creating unit 23 returns to step S503. Incidentally, in repeatedly executed steps S503 and S504, the question number “3-2” is determined as a question number with the presentation order 2 and “2” is stored in the row 267 of the presentation order column 178 in FIG. 9.

In step S506, the new-questionnaire-pattern creating unit 23 sets n+1→n. Specifically, the new-questionnaire-pattern creating unit 23 adds 1 to the variable “n”.

In step S507, the new-questionnaire-pattern creating unit 23 determines that the same question is implemented. Specifically, the new-questionnaire-pattern creating unit 23 directly determines, as a question number, the question number of the record relevant in “second” in step S502.

In FIG. 9, it is assumed that a question number is absent in a lower-order layer of the question number “3”. In this case, the question number “3” is directly determined as a question number with the presentation order “1”. “1” is stored in the row 263 of the presentation order column 178 in FIG. 9. This means that, although the questionnaire implementer desires to present a lower-order delved question in the next questionnaire opportunity because a degree of satisfaction of a customer is low, since a lower-order question is not prepared (or a lower-order question cannot be assumed because of a nature of a question), the same question is continuously presented.

In step S508, the new-questionnaire-pattern creating unit 23 sets i+1→i. Specifically, the new-questionnaire-pattern creating unit 23 adds 1 to the variable “i”. For convenience of explanation, in the following explanation, it is assumed that “i=2” after the step.

In step S509, the new-questionnaire-pattern creating unit 23 determines whether unprocessed selection order is absent or the number of questions reaches the maximum number of questions.

Specifically, first, the new-questionnaire-pattern creating unit 23 determines whether “i” is larger than the number of selection orders stored as the setting item of the setting information 31 (FIG. 4).

Second, the new-questionnaire-pattern creating unit 23 determines whether “n” is equal to or larger than a setting value corresponding to the setting item “maximum number of questions” of the setting information 31 (FIG. 4).

Third, when a determination result in “first” is “larger than the number of selection orders” or a determination result in “second” is “equal to or larger than the setting value” (“YES” in step S509), the new-questionnaire-pattern creating unit 23 proceeds to step S510. Otherwise (“NO” in step S509), the new-questionnaire-pattern creating unit 23 returns to step S502.

In the processing explained above, processing for determining a question on the basis of selection order set in advance ends. Thereafter, processing for determining a question not on the basis of selection order is performed.

Incidentally, after repeatedly executed step S502, a question number and presentation order of the question number are determined on the basis of the “selection order 2”, the “selection order 3”, and the like. At a point when the new-questionnaire-pattern creating unit 23 leaves the loop of steps S502 to S509 (proceeds to step S510) in FIG. 12, in the presentation order column 178 in FIG. 9, “1” is store in the row 264, “2” is stored in the row 267, “3” is stored in the row 252, “4” is stored in the row 255, “5” is stored in the row 272, “6” is stored in the row 275, “7” is stored in the row 257, and “8” is stored in the row 260. At the point when the new-questionnaire-pattern creating unit 23 leaves the loop of steps S502 to S509, n=8 and i=5. “9” is stored in the row 268 in the following steps.

In step S510, the new-questionnaire-pattern creating unit 23 sets n+1→n. Processing in the step is the same as step S503.

In step S511, the new-questionnaire-pattern creating unit 23 determines a question not on the basis of selection order. Specifically, first, the new-questionnaire-pattern creating unit 23 searches for one question in order from a question with smallest presentation order in the presentation order column 174 out of the question numbers stored in the questionnaire pattern 1 column 173, i.e., question numbers that are not stored in the questionnaire pattern 2 column 177 or question numbers having a highest-order layer in common with which are not stored in the questionnaire pattern 2 column 177. In this example, only the question number “4” is relevant.

Second, the new-questionnaire-pattern creating unit 23 stores “n” in the row 268 of the presentation order column 178. In this case, “9” is stored.

In step S512, the new-questionnaire-pattern creating unit 23 determines whether an unprocessed question is absent or the number of questions reaches the maximum number of questions. Specifically, first, the new-questionnaire-pattern creating unit 23 determines whether a question number presentation order of which is stored in the questionnaire pattern 1 column 173 in FIG. 9, i.e., a question number presentation order of which is not stored in the questionnaire pattern 2 column 177 or presentation order of a question number having a highest-order layer in common with which is not stored in the questionnaire pattern 2 column 177 is present.

Second, the new-questionnaire-pattern creating unit 23 determines whether “n” is equal to or larger than a setting value corresponding to the setting item “largest number of questions” of the setting information 31 (FIG. 4).

Third, when a determination result in “first” is “such a question number is absent” or a determination result in “second” is “equal to or larger than the setting value” (“YES” in step S512), the new-questionnaire-pattern creating unit 23 returns to step S410 or S413. Otherwise (“NO” in step S512), the new-questionnaire-pattern creating unit 23 returns to step S510.

At present, “n” is “9” and the setting value corresponding to the “maximum number of questions” is “9”. Therefore, the new-questionnaire-pattern creating unit 23 returns to step S410 or S413.

In the example explained above, the presentation order column 178 of the questionnaire pattern 2 column 177 is filled on the basis of the information of the questionnaire pattern 1 column 173.

The same applies when the presentation order column 182 of the questionnaire pattern 3 column 181 is filled on the basis of the information of the questionnaire pattern 2 column 177. A process in which the presentation order column 182 is filled is briefly explained.

(1) As a premise, a setting value corresponding to the “maximum number of questions” is “10”.

(2) The “setting orders 1 to 4” of the setting item and setting values corresponding to the setting orders are as shown in FIG. 4. Therefore, in the processing up to step S509, “1”, “2”, . . . , and “8” are already stored in the presentation order column 182.

(3) In the processing in step S510 and subsequent steps, as candidates of question numbers with the presentation order 9 and the presentation order 10, “4”, “5-1”, and “5-2” are present. The presentation orders in the presentation order column 178 of the question numbers are respectively “9”, “5”, and “6”. Therefore, the question number “5-1” are determined as a question number with the presentation order 9 (the row 272 of the presentation order column 182) and the question number “5-2” is determined as a question number with the presentation order 10 (the row 275 of the presentation order column 182).

The processing in steps S501 to S512 explained above is detailed processing in step S407 and is detailed processing of steps S408 and S409 as well. However, in step S501 explained as details of steps S408 and S409, the sections “second, acquires a per-customer questionnaire pattern (presentation order and a question number corresponding to the presentation order) of the target customer record from the per-customer questionnaire information 34 (FIG. 7),” and “third, in the questionnaire pattern transition information 36 (FIG. 9) associated with the target customer ID,” respectively read “second, acquires a common questionnaire pattern (presentation order and a question number corresponding to the presentation order) from the common questionnaire information 33 (FIG. 6),” and “third, in the questionnaire pattern transition information 36 (FIG. 9) for a common questionnaire pattern,”.

Details of Step S304

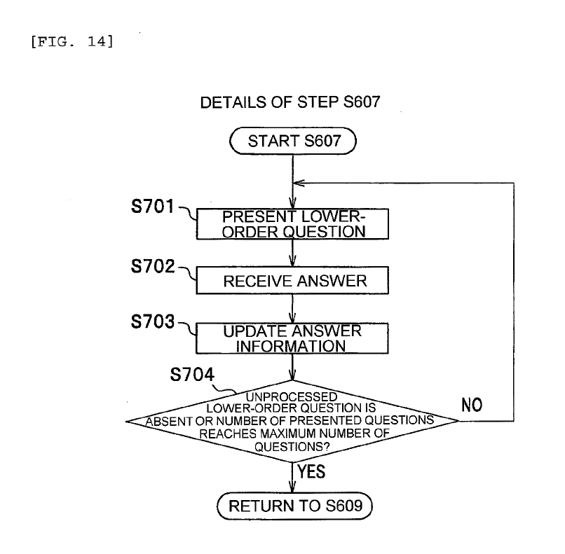

Details of step S304 are explained with reference to FIG. 13.

In step S601, the questionnaire implementing unit 22 acquires a record of per-customer questionnaire information. Specifically, the questionnaire implementing unit 22 searches through the per-customer questionnaire information 34 (FIG. 7) using the target customer ID as a search key and acquires a per-customer questionnaire pattern (a plurality of combinations of question numbers and presentation orders of the question numbers) of a relevant record.

In step S602, the questionnaire implementing unit 22 presents a question. Specifically, first, the questionnaire implementing unit 22 searches through the question information 32 (FIG. 5) using, as a search key, a question number with smallest presentation order among un-presented question numbers (referred to as “presentation question number”) from the per-customer questionnaire pattern acquired in step S601 and acquires a question of a relevant record.

Second, the questionnaire implementing unit 22 displays the acquired question on the output device of the terminal apparatus for answering 3. At this point, the sequential answer screen 42 (FIG. 3(a)) is displayed.

In step S603, the questionnaire implementing unit 22 receives an answer. Specifically, the questionnaire implementing unit 22 receives selection of one of “1” to “5” from the answer options 64 of the sequential answer screen 42 and pressing of the “proceeds to the next question” button 67 by the customer.

In step S604, the questionnaire implementing unit 22 determines whether the answer is different from the last answer. Specifically, first, the questionnaire implementing unit 22 acquires an average value of cells having the target customer ID on the ordinate and having the presentation question number on the abscissa in the section 202 of the answer information 35 (FIG. 8).

Second, the questionnaire implementing unit 22 calculates an absolute value of a difference between the acquired average value and a value of the answer acquired in step S603.

Third, the questionnaire implementing unit 22 compares the setting value of the setting item (question dynamic addition criteria” of the setting information 31 (FIG. 4) and the absolute value of the difference. When the absolute value of the difference is equal to or larger than the setting value (“YES” in step S604), the questionnaire implementing unit 22 proceeds to step S605. Otherwise (“NO” in step S604), the questionnaire implementing unit 22 proceeds to step S608.

In step S605, the questionnaire implementing unit 22 updates the answer information. Specifically, first, the questionnaire implementing unit 22 creates a new record (row), stores the target customer ID in the customer ID column 152, and stores the value of the answer received in step S603 in a cell having the presentation question number on the abscissa in the section 201 of the answer information 35 (FIG. 8). When passing step S605 in the repetition loop, the questionnaire implementing unit 22 stores the value of the answer acquired in step S603 in a cell having the target customer ID on the ordinate and having the presentation question number on the abscissa.

Second, the questionnaire implementing unit 22 updates the section 202 and the section 203 on the basis of the updated information of the section 201.

In step S606, the questionnaire implementing unit 22 determines whether a lower-order question is present. Specifically, when a lower-order question number of the presentation question number is present in the question information 32 (FIG. 5) (“YES” in step S606), the questionnaire implementing unit 22 proceeds to step S607. Otherwise (“NO” in step S606), the questionnaire implementing unit 22 proceeds to step S609.

In step S607, the questionnaire implementing unit 22 presents a lower-order question and receives an answer. Details of step S607 are explained below.

In step S608, the questionnaire implementing unit 22 updates the answer information.

Processing in step S608 is the same as the processing in step S605.

In step S609, the questionnaire implementing unit 22 determines whether an un-presented question is absent or the number of presented questions reaches the maximum number of questions. Specifically, first, the questionnaire implementing unit 22 determines whether an un-presented question number is present in the question numbers included in the per-customer questionnaire pattern acquired in step S601.

Second, the questionnaire implementing unit 22 determines whether the number of presented questions is equal to or larger than the setting value corresponding to the setting item (maximum number of questions” of the setting information 31 (FIG. 4).

Third, when a determination result in “first” is “absent” or a determination result in “second” is “equal to or larger than the setting value” (“YES” in step S609), the questionnaire implementing unit 22 ends the overall processing procedure. Otherwise (“NO” in step S609), the questionnaire implementing unit 22 returns to step S602.

Details of Step S607

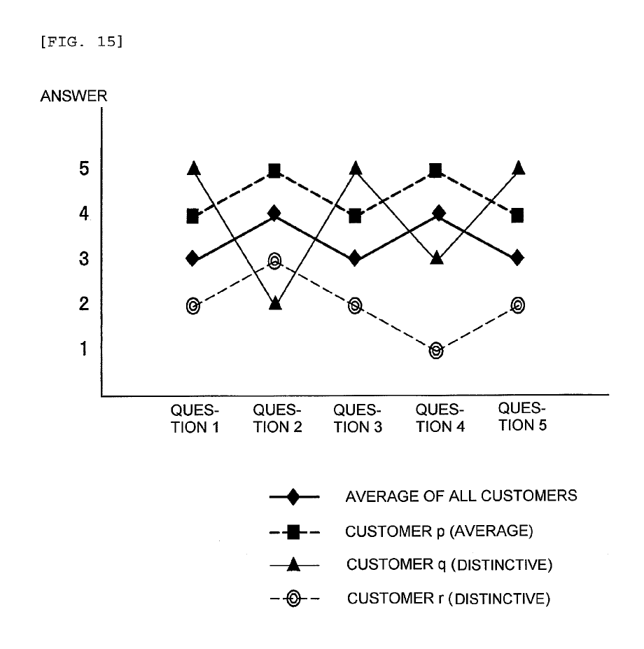

Details of step S607 are explained with reference to FIG. 14.

In step S701, the questionnaire implementing unit 22 presents a lower-order question. Specifically, first, the questionnaire implementing unit 22 acquires one lower-order question number of the presentation question number (referred to as “lower-order presentation question number”) in the question information 32 (FIG. 5). When a plurality of candidates of question numbers are present in the same layer, the questionnaire implementing unit 22 acquires one question number having a small value of priority among branch numbers.

Second, the questionnaire implementing unit 22 displays a question corresponding to the lower-order presentation question number on the output device of the terminal apparatus for answering 3. At this point, it is assumed that the sequential answer screen 42 (FIG. 3(b)) is displayed.

In step S702, the questionnaire implementing unit 22 receives an answer.

Processing in step S702 is the same as the processing in step S603.

In step S703, the questionnaire implementing unit 22 updates the answer information. Specifically, first, the questionnaire implementing unit 22 stores a value of the answer acquired in step S702 in a cell having the target customer ID on the ordinate and having the lower-order presentation question number on the abscissa in the section 201 of the answer information 35 (FIG. 8).

Second, the questionnaire implementing unit 22 updates the section 202 and the section 203 on the basis of the updated information of the section 201.

In step S704, the questionnaire implementing unit 22 determines whether an un-presented lower-order question is absent or the number of presented questions reaches the maximum number of questions. Specifically, first, the questionnaire implementing unit 22 determines whether an un-presented lower-order presentation question number is present.

Second, the questionnaire implementing unit 22 determines whether the number of presented questions is equal to or larger than the setting value corresponding to the setting item (maximum number of questions” of the setting information 31 (FIG. 4).

Third, when a determination result in “first” is “absent” or a determination result in “second” is “equal to or larger than the setting value” (“YES” in step S704), the questionnaire implementing unit 22 returns to step S609. Otherwise (“NO” in step S704), the questionnaire implementing unit 22 returns to step S701.

The present invention is not limited to the embodiment explained above and can be changed and carried out without departing from the spirit of the present invention.

### REFERENCE SIGNS LIST

1 questionnaire creation supporting system
2 questionnaire implementing apparatus
3 terminal apparatus for answering
4 network
11 central control device (control unit)
12 main storage device (storing unit)
13 auxiliary storage device (storing unit)
14 communication device
15 input device
16 output device
21 questionnaire-content determining unit
22 questionnaire implementing unit
23 new-questionnaire-pattern creating unit
31 setting information
32 question information
33 common questionnaire information
34 per-customer questionnaire information
35 answer information
36 questionnaire pattern transition information
41 list answer screen
42 sequential answer screen

1. A questionnaire creation supporting system comprising:
a terminal apparatus for answering used by a respondent to a questionnaire in which a plurality of questions to be answered with numerical values are presented; and
a questionnaire implementing apparatus connected to the terminal apparatus for answering and configured to implement the questionnaire, wherein
the questionnaire implementing apparatus includes:
a storing unit having stored therein question information in which the questions that should be presented in the questionnaire are hierarchically stored and a questionnaire pattern that indicates, in association with the respondent, the questions and presentation order, which is order in which the questions should be presented in the questionnaire; and
a control unit configured to acquire, according to a representative value of numerical values of answers to questions presented in the past, selection order, which is order for updating the questions presented in the past to a lower-order layer, place the questions presented in the past in order according to the acquired selection order, acquire lower-order questions concerning the questions presented in the past from the question information, set order of the acquisition of the lower-order questions as a new version of the presentation order, update, in association with the respondent, the questionnaire information with the questionnaire pattern that indicates the acquired lower-order questions and the new version of the presentation order, and display, according to the updated presentation order, the acquired lower-order questions on the terminal apparatus for answering.

2. The questionnaire creation supporting system according to claim 1, wherein
the questionnaire pattern is any one of an individual questionnaire pattern targeting a specific respondent and a common questionnaire pattern not targeting a specific respondent, and
the control unit of the questionnaire implementing apparatus compares a representative value of numerical values of answers to questions presented in the past concerning a respondent who is a target of the common questionnaire pattern and a representative value of answers to questions presented in the past concerning all respondents and determines, on the basis of a result of the comparison, that the respondent is set as a target of the individual questionnaire pattern.

3. The questionnaire creation supporting system according to claim 2, wherein the representative value of numerical values of answers to questions presented in the past concerning a respondent who is a target of the common questionnaire pattern and the representative value of answers to questions presented in the past concerning all respondents are calculated on the basis of a difference between a representative value of numerical values of answers to respective questions presented in the past and a representative value of numerical values of answers to all questions presented in the past.

4. The questionnaire creation supporting system according to claim 1, wherein the control unit of the questionnaire implementing apparatus displays the questions one by one on the terminal apparatus for answering, calculates a difference between a numerical value of an answer of the respondent to the displayed question and a representative value of numerical values of answers in the past of the respondent to the question, and, when the calculated difference is equal to or larger than a predetermined threshold, determines a lower-order question of the question and displays the determined lower-order question on the terminal apparatus for answering.

5. A questionnaire implementing apparatus connected to a terminal apparatus for answering used by a respondent to a questionnaire in which a plurality of questions to be answered with numerical values are presented, the questionnaire implementing apparatus implementing the questionnaire,
the questionnaire implementing apparatus comprising:
a storing unit having stored therein question information in which the questions that should be presented in the questionnaire are hierarchically stored and a questionnaire pattern that indicates, in association with the respondent, the questions and presentation order, which is order in which the questions should be presented in the questionnaire; and
a control unit configured to acquire, according to a representative value of numerical values of answers to questions presented in the past, selection order, which is order for updating the questions presented in the past to a lower-order layer, place the questions presented in the past in order according to the acquired selection order, acquire lower-order questions concerning the questions presented in the past from the question information, set order of the acquisition of the lower-order questions as a new version of the presentation order, update, in association with the respondent, the questionnaire information with the questionnaire pattern that indicates the acquired lower-order questions and the new version of the presentation order, and display, according to the updated presentation order, the acquired lower-order questions on the terminal apparatus for answering.

6. The questionnaire implementing apparatus according to claim 5, wherein
the questionnaire pattern is any one of an individual questionnaire pattern targeting a specific respondent and a common questionnaire pattern not targeting a specific respondent, and
the control unit of the questionnaire implementing apparatus compares a representative value of numerical values of answers to questions presented in the past concerning a respondent who is a target of the common questionnaire pattern and a representative value of answers to questions presented in the past concerning all respondents and determines, on the basis of a result of the comparison, that the respondent is set as a target of the individual questionnaire pattern.

7. The questionnaire implementing apparatus according to claim 6, wherein the representative value of numerical values of answers to questions presented in the past concerning a respondent who is a target of the common questionnaire pattern and the representative value of answers to questions presented in the past concerning all respondents are calculated on the basis of a difference between a representative value of numerical values of answers to respective questions presented in the past and a representative value of numerical values of answers to all questions presented in the past.

8. The questionnaire implementing apparatus according to claim 5, wherein the control unit displays the questions one by one on the terminal apparatus for answering, calculates a difference between a numerical value of an answer of the respondent to the displayed question and a representative value of numerical values of answers in the past of the respondent to the question, and, when the calculated difference is equal to or larger than a predetermined threshold, determines a lower-order question of the question and displays the determined lower-order question on the terminal apparatus for answering.

9. A non-transitory recording medium having stored therein a program for causing a questionnaire implementing apparatus to function, the questionnaire implementing apparatus being connected to a terminal apparatus for answering used by a respondent to a questionnaire in which a plurality of questions to be answered with numerical values are presented and implementing the questionnaire,
the program causing:
a storing unit of the questionnaire implementing apparatus to store question information in which the questions that should be presented in the questionnaire are hierarchically stored and a questionnaire pattern that indicates, in association with the respondent, the questions and presentation order, which is order in which the questions should be presented in the questionnaire; and
a control unit of the questionnaire implementing apparatus to execute processing for acquiring, according to a representative value of numerical values of answers to questions presented in the past, selection order, which is order for updating the questions presented in the past to a lower-order layer, placing the questions presented in the past in order according to the acquired selection order, acquiring lower-order questions concerning the questions presented in the past from the question information, setting order of the acquisition of the lower-order questions as a new version of the presentation order, updating, in association with the respondent, the questionnaire information with the questionnaire pattern that indicates the acquired lower-order questions and the new version of the presentation order, and displaying, according to the updated presentation order, the acquired lower-order questions on the terminal apparatus for answering.

10. The non-transitory recording medium according to claim 9, wherein
the questionnaire pattern is any one of an individual questionnaire pattern targeting a specific respondent and a common questionnaire pattern not targeting a specific respondent, and
the program causes the control unit to execute processing for comparing a representative value of numerical values of answers to questions presented in the past concerning a respondent who is a target of the common questionnaire pattern and a representative value of answers to questions presented in the past concerning all respondents and determining, on the basis of a result of the comparison, that the respondent is set as a target of the individual questionnaire.

11. The non-transitory recording medium according to claim 10, wherein the representative value of numerical values of answers to questions presented in the past concerning a respondent who is a target of the common questionnaire pattern and the representative value of answers to questions presented in the past concerning all respondents are calculated on the basis of a difference between a representative value of numerical values of answers to respective questions presented in the past and a representative value of numerical values of answers to all questions presented in the past.

12. The non-transitory recording medium according to claim 9, wherein the program causes the control unit to execute processing for displaying the questions one by one on the terminal apparatus for answering, calculating a difference between a numerical value of an answer of the respondent to the displayed question and a representative value of numerical values of answers in the past of the respondent to the question, and, when the calculated difference is equal to or larger than a predetermined threshold, determining a lower-order question of the question and displaying the determined lower-order question on the terminal apparatus for answering.
